(19) United States
(12) Patent Application Publication
(10) Pub. No.: US 2005/0087930 A1
(43) Pub. Date: Apr. 28, 2005

(54) Locating bore for press fit and sealing of a press fit component

(76) Inventors: Anthony T. D'Amico, Troy, MI (US); Richard Gady, Rochester Hills, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/352,401

(22) Filed: Jan. 28, 2003

(51) Int. Cl. F16J 15/02

(52) U.S. Cl. 277/312

(57) ABSTRACT

The bore geometry of a housing for a press fit component includes a locating bore adjacent a press fit bore and extends for an axial length to provide an index on a press fit component outer diameter. The locating bore is of a diameter which provides a clearance fit for receipt of the seal outer diameter such that the seal assembly is received into the locating bore and upon a chamfer between the locating bore and the bore. Complex alignment and indexing tooling is therefore effectively eliminated. The locating bore also provides a reception area for a gasket material once the seal assembly is press fit into the bore.

### BACKGROUND OF THE INVENTION

The present invention relates to press fit components, and more particularly to a bore geometry to receive a press fit seal assembly and a method of installation thereof.

Various housings include a bore to receive a press fit member such as a seal. The seal provides a rotational interface between the housing and a rotating shaft such as common to a differential carrier assembly for an axle assembly. Proper installation of press fit components may often be a relatively complex procedure which requires high press forces and tight tolerances.

A press fit seal utilizes an interference fit between the seal outer diameter and a housing bore diameter. The seal outer diameter is typically press fit into the bore diameter with a tool to provide alignment of the seal with the bore. Even a slight misalignment of the seal to the bore may result in an unacceptable misalignment. Some seals have a rubber outer diameter which may be even more easily damaged from an initial misalignment.

Relatively complex and expensive tooling is utilized to press fit the seal into the bore which is often chamfered in an attempt to initiate the seating of the seal. Even though the tooling indexes in a number of locations on the housing and the seal, misalignment may still occur due to the strict tolerance requirements. Minor misalignment is overcome by the force of the press which may yield the seal outside diameter such that the seal is press fit in a cocked or offset orientation. Such minor misalignment difficult to detect through conventional quality control procedures. However, even a relatively small misalignment may result in a failed seal. Furthermore, the minor misalignment may still go unnoticed and be misdiagnosed as a shaft to bore misalignment problem resulting in costly overhaul, repair and/or replacement of relatively expensive components.

In addition to assuring proper alignment, press fit seal components must also provide a fluid tight barrier. Even when properly aligned, conventional seals often require a resilient gasket material coating to seal the seal outer diameter into the housing. Such a resilient material is often incompatible with press fitting as the resilient gasket material may be stripped from the seal outer diameter during the press fitting operations. A properly aligned seal may therefore still be subject to leakage.

Eventually, even if initially properly installed and sealed, the press fit component may need to be replaced in a field environment. Such replacement is quite difficult to achieve in a field environment in which relatively large and complex tooling available in a manufacturing setting is unavailable.

Accordingly, it is desirable to provide a bore geometry to receive a press fit component and a method of installation thereof which assures alignment of the press fit component without damaging a resilient gasket material coating. It is further desirable to provide a press fit component which may be replaced in a relatively austere field environment.

### SUMMARY OF THE INVENTION

The bore geometry of a housing according to the present invention provides a bore diameter for the interference fit of a press fit component such as a seal assembly. A locating bore is located adjacent the bore and extends for an axial length to provide an index on the seal outer diameter. The locating bore is of a diameter which provides a tightly held clearance fit for receipt of the seal outer diameter. That is, the seal assembly is received into the locating bore such that the seal assembly rests upon a chamfer between the locating bore and the bore.

A gasket material is located about the seal outer diameter. By providing a locating bore which closely fits the seal outer diameter the locating bore provides a reception area for the gasket material once the seal assembly is press fit into the bore. An effective oil seal is therefore provided between the seal outer diameter and the bore by the present invention.

In a method of assembly according to the present invention, the seal assembly is initially placed into the locating bore such that the seal rests against a chamfer between the locating bore and the press fit bore. The seal assembly is thereby aligned with the press fit bore by the placement of the seal assembly into the locating bore. Complex alignment and indexing tooling is therefore effectively eliminated.

A flat surface such as a mandrel which extends from a press is then utilized to press the seal assembly into the bore. As the locating bore provides alignment, only a relatively simple press with minimum indexing is required.

The present invention therefore provides a bore geometry to receive a press fit component and a method of installation thereof which assures alignment of the press fit component and the formation of a gasket material. The present invention further provides a press fit component which may be replaced in a relatively austere field environment.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a general sectional view of a differential carrier assembly for use with the present invention;

FIG. 2 is an expanded sectional view of a press fit seal assembly;

FIG. 3A is an exploded partial sectional view of the seal assembly adjacent a bore having a geometry according to the present invention;

FIG. 3B is an exploded partial sectional view of the seal assembly adjacent a bore having a geometry according to the present invention;

FIG. 4 is the seal assembly initially placed into a locating bore prior to a pressing operation according to the present invention; and

FIG. 5 is the seal assembly pressed into place after a pressing operation according to the present invention.

### DETAILED DESCRIPTION OF THE PREFERRED EMBODIMENT

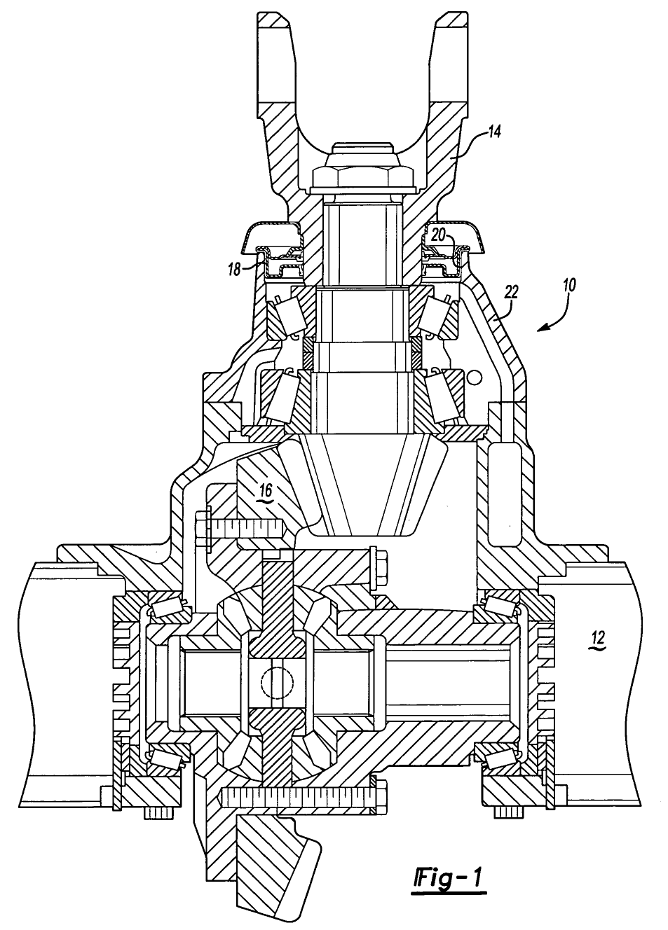

FIG. 1 illustrates a general sectional view of a differential carrier assembly 10 for an axle assembly 12 or the like. The carrier assembly 10 receives an input through an input yoke 14 which then drives the axle assembly 12 through a gear train 16 or the like. The yoke 14 rotates within a seal assembly 18 which is pressed into a bore 20 defined by a housing 22. It should be understood that although a press fit seal assembly is disclosed in the illustrated embodiment, various press fit components such as cover joints and bearing assemblies will also benefit from the present invention.

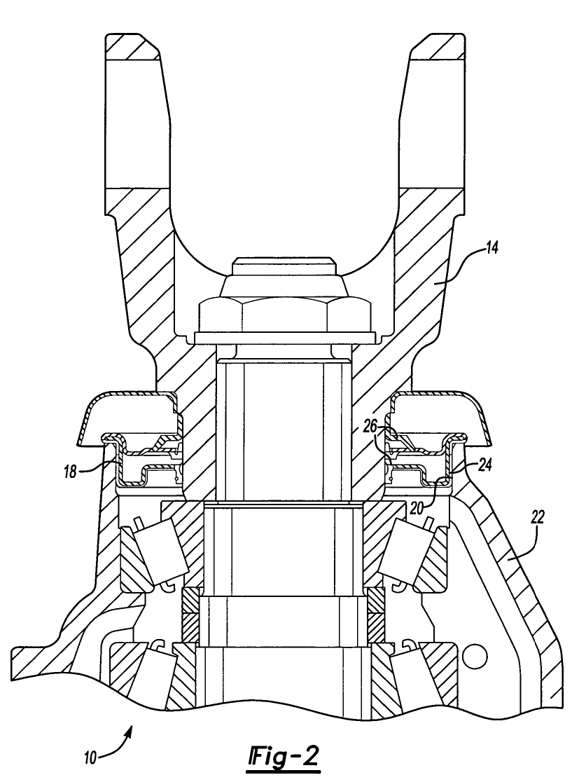

Referring to FIG. 2, the seal assembly 18 defines a seal outer diameter 24 which is press fit into the bore 20. Press fit as defined herein refers to an interference fit. The seal assembly 18 is preferably formed as a formed sheet metal component that supports one or more resilient seals 26 to seal the rotating input yoke 14 to prevent the escape of oil from within the differential carrier assembly 10 and the ingestion of debris into the carrier assembly 10.

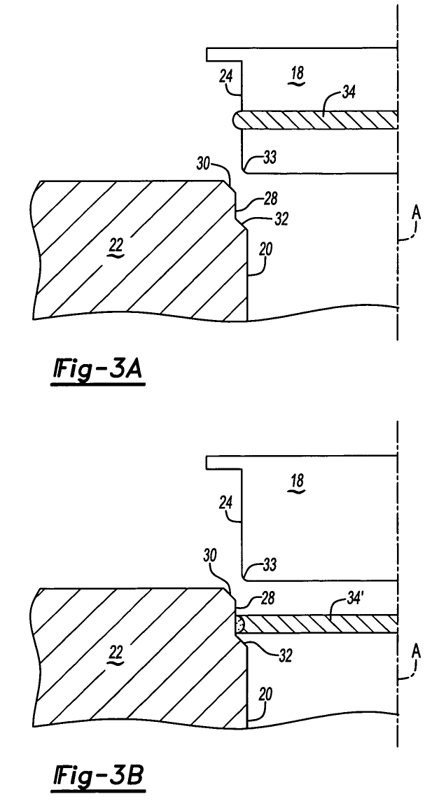

Referring to FIG. 3, the bore 20 is defined about an axis A. The bore 20 is of a diameter which provides an interference fit for receipt of the seal outer diameter 24. A locating bore 28 is located adjacent the bore 20 to provide a step-like geometry in cross section. That is, the locating bore 28 and the bore 20 provide an inner diameter which are parallel to the seal outer diameter 24. The locating bore 28 extends for an axial length great enough to provide an index on the seal outer diameter 24. That is, the axial depth is of distance which allows a relatively stable receipt of the seal assembly 18.

A chamfer 30, 32 are preferably located along the top of the locating bore 28 and between the locating bore 28 and the bore 20. A chamfer 33 is also preferably located on the insert edge of the seal assembly 18. The chamfers 30, 32, 33 assist in locating and driving the seal assembly 18 into the bore 20. It should be understood that the term “chamfer” as used herein includes radiuses and any broken edge.

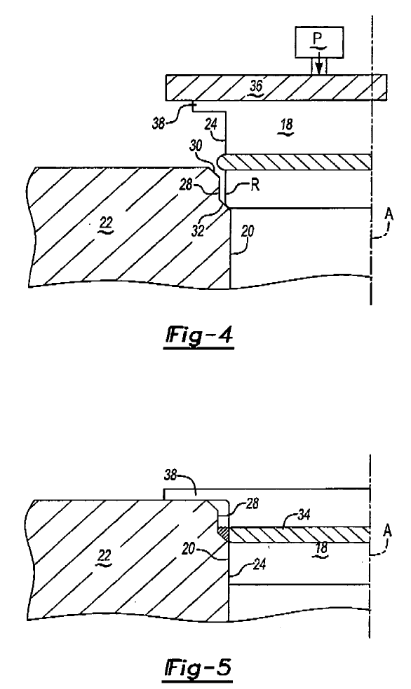

The locating bore 28 is of a diameter which provides a clearance fit for receipt of the seal outer diameter 24. That is, the seal assembly 18 is received into the locating bore 28 such that the seal assembly 18 rests upon the chamfer 32 between the locating bore 28 and the press fit bore 20 (FIG. 4). The locating bore 28 is preferably of a diameter to closely receive the seal assembly 18. That is, the locating bore 28 is just large enough to receive the seal outer diameter 24 when in a tolerance stack up condition.

A gasket material 34 is located about the seal outer diameter 24. Preferably, a flow on gasket material or other liquid gasket material such as LOCTITE 518® is beaded along the seal outer diameter 24. The gasket material 34′ may alternatively or additionally be located about the locating bore 28 (FIG. 3B). Preferably, a flow on gasket material or other liquid gasket material such as LOCTITE 518® is beaded along the inner wall of the locating bore 28.

By providing a locating bore 28 which closely fits the seal outer diameter 24 the locating bore 28 provides a reception area R for the gasket material 34 once the seal assembly 18 is press fit into the press fit bore 20 (FIG. 5). It should be understood that the reception area R is shown in an exaggerated form for sake of clarity. Preferably, the reception area R is small enough to assist in quick curing of the gasket material. The smaller the reception area R, the more readily a gasket material such as LOCTITE 518® cures. Typically, LOCTITE 518® provides a rapid and efficient curing time within clearances less than 0.010 of an inch. That is, the locating bore 28 becomes at least partially filled with the gasket material 34 with minimum concern for stripping the gasket material away from the seal assembly 18. An effective outside diameter oil seal is therefore provided by the present invention.

Referring to FIG. 4, the seal assembly 18 is initially placed into the locating bore 28. The seal assembly 18 is preferably manually located into the locating bore 28.

That is, the seal assembly 18 is simply dropped into place by hand. The seal assembly 18 rests upon the chamfer 32 between the locating bore 28 and the press fit bore 20 prepositioned for a pressing operation (FIG. 5). The seal assembly 18 is thereby automatically aligned with the press fit bore 20 by the placement of the seal assembly 18 into the locating bore 28. Complex alignment and indexing tooling, which can be ineffective, are therefore effectively eliminated.

A flat surface 36 such as a mandrel which extends from a press (illustrated schematically at 38) is then utilized to press the seal assembly 18 into the press fit bore 20. As the locating bore 28 provides alignment, only a relatively simple press is required. A radial flange 38 provides depth control of the pressing operation.

Moreover, the axial length of the locating bore 28 tends to index the seal assembly 18 perpendicular to the press fit bore 20 even if the seal assembly 18 is initially not exactly perpendicular thereto. That is, the locating bore tends to correct misalignment when the seal assembly 18 is pressed by the flat surface 36 in comparison to a conventional tool which tends to press the seal crooked if the seal is initially misaligned.

Referring to FIG. 5, the locating bore 28 provides a reception area for the gasket material 34 once the seal assembly 18 is press fit into the press fit bore 20. That is, the locating bore 28 becomes at least partially filled with the resilient gasket material 34 with minimum concern for stripping. Conventional seals typically included gasket material which attempted to fill adjacent the chamfer area with intermittent success due to the angular or rounded chamfer surface. Moreover, the gasket material tended to strip away from the bore during press fitting in the conventional method as there was no clearance to receive the material, i.e., the gasket material was sheared away. By providing the locating bore 28 the gasket material 34 is provided with an annular clearance which readily receives and compresses the resilient gasket material to provide an effective oil tight seal.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention maybe practiced otherwise than as specifically described. For that reason the following claims should be studied to determine the true scope and content of this invention.

1-8. (canceled)

9. A press fit assembly comprising:
a press fit component defining a portion having an outer diameter; and
a housing defining a bore having a portion with an inner diameter smaller than said outer diameter, and a locating bore larger than the outer diameter.

10. The press fit assembly as recited in claim 9, further comprising a chamfer on said locating bore.

11. The press fit assembly as recited in claim 9, further comprising a chamfer on said bore inner diameter adjacent said locating bore.

12. The press fit assembly as recited in claim 9, wherein said locating bore is concentric to said outer diameter.

13. The press fit assembly as recited in claim 9, wherein said locating bore and said inner diameter define a step in cross section.

14. The press fit assembly as recited in claim 9, wherein said press fit component sits within said locating bore and upon said inner diameter prior to a press operation.

15. The press fit assembly as recited in claim 9, further comprising a resilient gasket material extending outwardly from said outer diameter.

16. The press fit assembly as recited in claim 9, further comprising a resilient gasket material extending inwardly from said locating bore.

17. The press fit assembly as recited in claim 9, further comprising a bead of a fluid resilient gasket material extending outwardly from said outer diameter.

18. The press fit assembly as recited in claim 9, further comprising a resilient gasket material extending upon said outer diameter, said resilient gasket material at least partially filling said locating bore.

19. The press fit assembly as recited in claim 9, wherein said press fit component comprises an oil seal.

20. The press fit assembly as recited in claim 9, wherein said press fit component comprises a bearing.

21. A press fit assembly comprising:
a press fit seal having a metallic portion with an outer diameter;
a housing defining a bore having a metallic portion with an inner diameter smaller than said outer diameter to provide an interference fit, and a locating bore larger than the outer diameter for placement of said press fit seal with a clearance fit prior to engagement of said outer diameter within said inner diameter; and
said outer diameter of said metallic portion of said press fit seal received within said inner diameter of said metallic portion of said bore.

22. The press fit assembly as recited in claim 21, further comprising a resilient gasket material located upon said press fit seal prior to engagement of outer diameter within said inner diameter, said resilient gasket material located at least partially within said locating bore after engagement of said outer diameter bore within said inner diameter.

23. A method as recited in claim 5, wherein said step (1) comprises the step of:
indexing the component within the locating bore to index the component into the bore along a central axis, even if the component is initially not exactly perpendicular thereto.

24. The press fit assembly as recited in claim 9, wherein said metallic portion of said press fit component is manufactured of a formed sheet metal.

25. The press fit assembly as recited in claim 21, wherein said metallic portion of said press fit seal is manufactured of a formed sheet metal

26. The press fit assembly as recited in claim 9, wherein said housing is part of a differential carrier assembly housing.

27. The press fit assembly as recited in claim 21, wherein said housing is part of a differential carrier assembly housing.

28. The press fit assembly as recited in claim 24, wherein said housing is part of a differential carrier assembly housing.

29. The press fit assembly as recited in claim 19, further comprising an input yoke mounted within said oil seal.
